(19) United States
(12) Patent Application Publication
(10) Pub. No.: US 2007/0180151 A1
(43) Pub. Date: Aug. 2, 2007

(54) Model driven message processing

(75) Inventors: James P. Richardson, St. Paul, MN (US); Jon P. Schewe, Maple Grove, MN (US); Mark D. Dietz, St. Paul, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/231,006

(22) Filed: Sep. 20, 2005

(51) Int. Cl. G06F 15/16

(52) U.S. Cl. 709/248

(57) ABSTRACT

Systems and methods for model driven message processing are provided. In one embodiment, a method for propagating information object updates is provided. The method comprises logging a sequence of update requests made to a local information object by one or more applications, correlating the sequence of update requests with one or more message formats based on message semantics defined by a message model, encoding the sequence of update requests as one or more messages based on application-layer message formats defined by the message model, and communicating the one or more messages to one or more remote computer systems.

### CROSSREFERENCES

This application is also related to the following co-pending United States patent application filed on Nov. 3, 2004, which is hereby incorporated herein by reference:

U.S. patent application Ser. No. 10/980,778 (attorney docket number H0008671-1633 entitled “Object Replication Using Information Quality of Service”) and which is referred to here as the '778 Application.

### TECHNICAL FIELD

The present invention generally relates to computer databases and more specifically to synchronization of duplicate databases on a network.

### BACKGROUND

In many situations, communications between computers linked by a communications network is constrained to use a pre-defined protocol that includes a pre-defined set of message formats (e.g., Aeronautical Radio Inc. (ARINC) 1999, Data link ground system standard and interface specification (DGSS/IS), ARINC Specification 620-4, Annapolis, Md; and United States Department of Defense (US DOD) 1999, Tactical digital information link (TADIL) J message standard, MIL-STD-6016A, April 30). Use of a pre-defined protocol is essential for interoperability among independently-developed systems. The protocols required for two systems to interoperate are typically defined in several layers (e.g. the seven layers defined by the OSI reference model ISO/IEC 1994). Achieving interoperability between systems requires adherence to protocol specifications at all layers. Application-layer protocols for providing application-layer interoperability have been defined for a variety of purposes-file transfer, electronic mail, database access, web browsing, etc. A number of application-layer protocols have been defined for monitoring and control functions in aerospace, defense, industrial automation, telecommunications, and other industries.

Typically in these networks, one or more of the computers comprise a local information object that holds information to be shared with other computers. The local information object may be a database. Applications running on a computer read and update their local information object. To maintain information object synchronization between computers on the network, update operations that alter the local object of one computer must be communicated to the other computers. Two problems arise in maintaining information object synchronization. First, applications issue update operations to their local information objects in a format largely based on the structure of the local object. Because these update operations are not in the format of messages compliant with a pre-defined protocol, they cannot be directly communicated to other computers by a communications network that is constrained to use a pre-defined protocol. Second, because reducing communication cost is important in environments, such as wireless networks, where bandwidth is at a premium and availability is intermittent, information object synchronization must be achieved in a manner that efficiently utilized network bandwidth.

For the reasons stated above and for other reasons stated below which will become apparent to those skilled in the art upon reading and understanding the specification, there is a need in the art for efficiently communicating information object updates in protocol constrained communications networks.

### SUMMARY

The Embodiments of the present invention provide methods and systems for model driven message processing and will be understood by reading and studying the following specification.

In one embodiment, an information object replication system is provided. The system comprises a log adapted to store records; a request logging function adapted to record a sequence of updates sent by one or more local applications to a local information object in the log; and an update propagation function in communication with the log, the update propagation function adapted to communicate one or more messages to one or more remote information objects, wherein the one or more messages represent updates to the local information object based on the sequence of updates, the update propagation function is further adapted to generate the one or more messages based on application-layer message formats and message semantics defined by a message model.

In another embodiment, a method for propagating information object updates is provided. The method comprises logging a sequence of update requests made to a local information object by one or more applications; correlating the sequence of update requests with one or more message formats based on message semantics defined by a message model; encoding the sequence of update requests as one or more messages based on application-layer message formats defined by the message model; and communicating the one or more messages to one or more remote computer systems.

In still another embodiment, a computer-readable medium having computer-executable instructions for performing a method for propagating information object updates is provided. The method comprises logging a sequence of update requests made to a local information object by one or more applications; correlating the sequence of update requests with one or more message formats based on message semantics defined by a message model; encoding the sequence of update requests as one or more messages based on application-layer message formats defined by the message model; and communicating the one or more messages to one or more remote computer systems.

In yet another embodiment, an information object replication system is provided. The system comprises means for logging a sequence of update requests made to a local information object by one or more applications; means for correlating the sequence of update requests with one or more message formats based on message semantics defined by a message model, the means for correlating responsive to the means for logging; means for encoding the sequence of update requests as one or more messages based on application-layer message formats defined by the message model, the means for encoding responsive to the means for correlation; and means for communicating the one or more messages to one or more remote computer systems, the means for communicating responsive to the means for encoding.

### DRAWINGS

Embodiments of the present invention can be more easily understood and further advantages and uses thereof more readily apparent, when considered in view of the description of the preferred embodiments and the following figures in which:

FIG. 1 is a diagram illustrating the synchronization of objects of one embodiment of the present invention;

FIG. 2 is a flow chart illustrating a method of one embodiment of the present invention; and

FIG. 3 is a diagram illustrating information object state updates using messages of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

With embodiments of the present invention, a computer sends protocol compliant messages across a communications network to convey information introduced by local applications as updates to the computer's local information object. Remote computer systems receiving the messages apply corresponding updates to their own information objects so that copies of the information distributed among various computers on the network remain synchronized. Information object updates and network messages are correlated with each other by message formats and semantics defined by a messaging model.

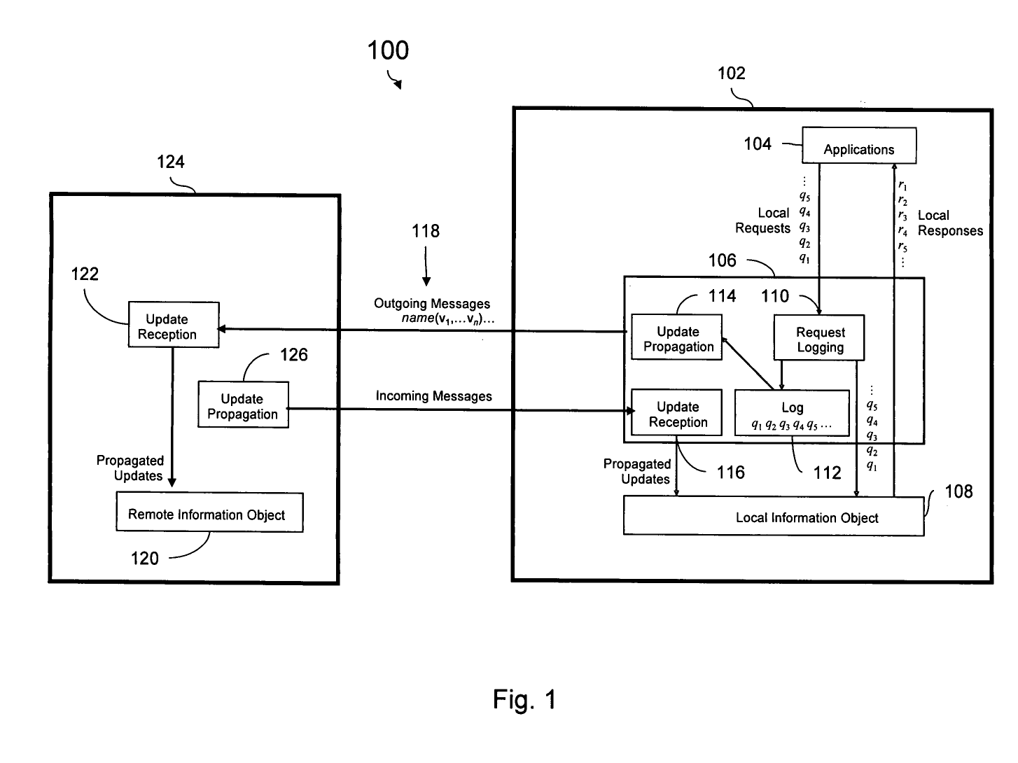

FIG. 1 illustrates the components of a computer system 102 of one embodiment of the present invention shown generally at 100. Within a database replication function 106, a request logging function 110 records into log 112 the sequence of requests (q₁, . . . qₙ) that one or more local applications 104 send to a local information object 108. In one embodiment, local information object 108 comprises a database. Record logging function 110 filters from log 112 any requests that do not actually cause a state change in local object 108. Thus, each request in log 112 represents an update to local object 108. In one embodiment, replication function 106 examines the logged sequence of requests, recognizes subsequences that match a message's operations semantics (as described below) and sends those messages to one or more remote computers 124 via one or more communications links 118.

In one embodiment, replication function 106 further comprises an update propagation function 114 coupled to communicate with log 112. Update propagation function 114 translates logged update requests into one or more messages allowed by the protocol constraints of communications link 118. In one embodiment, to conserve communications link 118 bandwidth, update propagation function 114 first transforms the logged update requests into a compressed sequence of requests as described in the '778 Application herein incorporated by reference.

To communicate updates applied to local information object 108 to one or more remote computers 124, update propagation function 114 follows a publish-subscribe message pattern using message formats compliant with a particular application-layer protocol. With a publish-subscribe message pattern, computer 102 sends locally-available information to one or more remote computers 124 on a periodic or event-driven basis. Publish-subscribe is also known by those skilled in the art as information push.

In one embodiment of the present invention, update propagation function 114 maps logged update requests into protocol compliant messages based on a messaging model. The messaging model defines 1) valid application-layer message formats for protocol compliant messages, 2) the state space structure and update operations which apply to the local information object 108, 3) and message semantics which correlate the update operations with protocol compliant messages. For each valid message of a protocol, the application-layer message format defines the permitted fields of the message, and the permitted type of information (string, real number, etc.) for each field. In one embodiment, the application-layer message format is defined using one of several standard notations such as, but not limited to, ASN. 1 (ITU 2002) and XML Schema (W3C 2004). A message's semantics are defined in terms of the state change it causes in an information object of a specific structure. The change is expressed as a sequence of update requests, q₁, . . . , qₙ, that are sent to an information object to effect the change. The sequence of requests used can depend on the current state of the object.

For example, in one embodiment, an application-layer message format is defined as name(v₁, . . . , vₙ), where v₁, . . . , vₙ are permitted fields for the message name. In one embodiment, the semantics for the message name(v₁, . . . , vₙ) are captured as a set of rules for the form in Table 1. In one embodiment, each rule comprises a precondition, pre₁ . . . preₘ, and a sequence of requests that will cause the desired state change if the precondition is satisfied.

TABLE 1
Specifying the semantics of message name(ν₁, . . . , νₙ)

| Precondition | Message Semantics |
|---|---|
| pre₁ | q₁₁, . . . , q₁ₙ_{₁} [symbol] name(ν₁, . . . , νₙ) |
| . . . | . . . |
| preₘ | q₁₁, . . . , q₁ₙ_{ₘ} [symbol] name(ν₁, . . . , νₙ) |

Through the message semantics defined by the messaging model, each message's meaning is defined as one or more sequences of update requests. Conversely, the messaging model also correlates sequences of update requests with one or more specific messages. In one embodiment, update propagation function 114 evaluates the contents of log 112, recognizes sequences of update requests defined by message semantics, and correlates the recognized sequences to one or more of the permitted message formats.

In one embodiment, correlating a sequence of requests with a message format also comprises satisfying one of the preconditions defined by the message semantics. For example, the correct message for an aircraft to transmit in order to communicate a sequence of update requests, q₁, . . . , qₙ, made to its local information object may depend on whether the aircraft has 1) left the terminal gate, 2) completed takeoff, 3) landed on a runway, or 4) returned to a terminal gate. Thus, different request sequences can be specified for different circumstances that are captured by the preconditions. In one embodiment, update propagation function 114 determines whether one or more of the preconditions are satisfied by directly referencing one or more state variables of local information object 108. In one embodiment, update propagation function 114 determines whether one or more of the preconditions are satisfied by referencing the sequence of update requests being converted to messages.

In one embodiment, when a remote computer 124 coupled to communication link 118 receives an incoming message, an update reception function 122 applies a sequences of update requests, as defined by its own messaging model, to remote information object 120. Using message semantics from the messaging model, update reception function 122 correlates the incoming message to the associated sequences of update requests. In one embodiment, computer 102 further comprises an update reception function 116 that receives similar updates from an update propagation function 126 of the one or more remote computer systems 124 and applies the updates to the local information object 108 as described with respect to update reception function 122. In one embodiment, when a remote computer coupled to communication link 118 receives an incoming message, an update reception function 122 applies a sequence of update requests, as defined by its own messaging model, to remote information object 120.

In one embodiment, correlating an incoming message format with a sequence of requests also comprises satisfying preconditions defined by message semantics. In that case, in one embodiment, update reception function 122 selects a requests sequence q₁, . . . , qₙ, for which one or more state variables of remote information object 120 satisfies the precondition. For example, the correct sequence of updates to apply to remote information object 120 upon receipt of a message from an aircraft may depend on whether one or more remote information object 120 state variables indicate that the aircraft has previously 1) left the terminal gate, 2) completed takeoff, 3) landed on a runway, or 4) returned to a terminal gate.

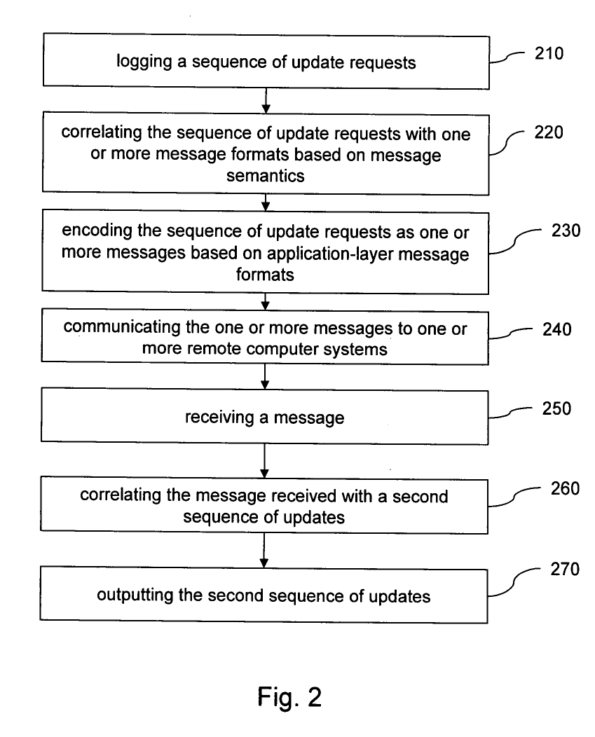

FIG. 2 is a flow chart illustrating a method for propagating information object updates of one embodiment of the present invention. The method begins at 210 with logging a sequence of update requests made to a local information object by one or more applications. In one embodiment, local application running on a computer system make changes to the information held by the local information object by sending the sequence of update requests. In one embodiment the sequence of update requests within the log is compressed. For example, where the log contains a first update request that updates a local information object state variable, and contains a subsequently received second update requests that again updates the same local information object state variable, only the state update resulting from the second update requests need be propagated to remote computer systems to maintain information synchronization. Additional information pertaining to such compression algorithms are described in the '778 Application herein incorporated by reference. The method proceeds to 220 with correlating the sequence of update requests with one or more message formats based on message semantics defined by a message model. Through the message semantics defined by the messaging model, each message's meaning is correlated with one or more sequences of update requests. In one embodiment, correlating the sequence of update requests includes satisfying one or more preconditions defined by the message semantics. In one embodiment, the method determines whether one or more preconditions are satisfied by referencing one or both of state variables within the local information object, or update requests within the logged sequence of updates. The method proceeds to 230 with encoding the sequence of update requests as one or more messages based on application-layer message formats defined by the message model. For each valid message of a protocol, the application-layer message format defines the permitted fields of the message, and the permitted type of information (string, real number, etc.) for each field. In one embodiment, when the messaging model identifies multiple ways to encode the sequence of update requests as one or more messages, the method chooses the one or more messages that result in a least cost encoding as described below in this specification. The method then proceeds to 240 with communicating the one or more messages to one or more remote computer systems. In one embodiment, the communication of the one or more messages further comprises timing the propagation of messages based on one or both of information quality of service accuracy requirements and information quality of service freshness requirements. Further details pertaining to information quality of service accuracy and freshness requirement are provided below and by the '778 Application herein incorporated by reference. In one embodiment, the method continues at 250 with receiving a message at remote computer system of the one or more remote computer systems and proceeds to 260 with correlating the message received with a second sequence of updates based on the application-layer message formats and message semantics defined by the message model. The method then proceeds to 270 with outputting the second sequence of updates to the remote information object. In one embodiment, the local information object is updated as described above by receiving one or more messages from a remote computer system of the one or more remote computer systems and translating those messages into a sequence of updates.

In one embodiment, update propagation function 114 determines which local information object 108 states to propagate based on one or both of information quality of service (IQoS) accuracy and freshness requirements, described by the '778 Application herein incorporated by reference. As described in the '778 Application, IQoS accuracy requirements control the selection of which states will be propagated from the local information object 108 to a destination information object 120 of the one or more remote computers 124. In one embodiment, a local information object 108 state must be propagated only if the change from the previously propagated state is large enough and the state has persisted for a sufficient time interval. The IQoS freshness requirement places a propagation delay bound Tₚ on the propagation time for propagating local information object 108 states to destination information object 120. In general, the larger the delay bound, the more flexibility communications network 118 has in allocating resources to propagate the local information object 108 states and the more resilient the replication function 106 is to temporary network unavailability.

When attempting to minimize network communications cost, it is important to know the cost of each message that might be used. This cost is generally determined by how a message's contents are represented as a sequence of bits for transmission, which also determines the message's length. For interoperability between computers, a message's encoding is also defined by the particular application-layer protocol enforced for communication network 118. Often, the message format and encoding are defined together. In other cases (as with ASN. 1), encoding rules are specified separately and different encoding rules can be used for the same message format.

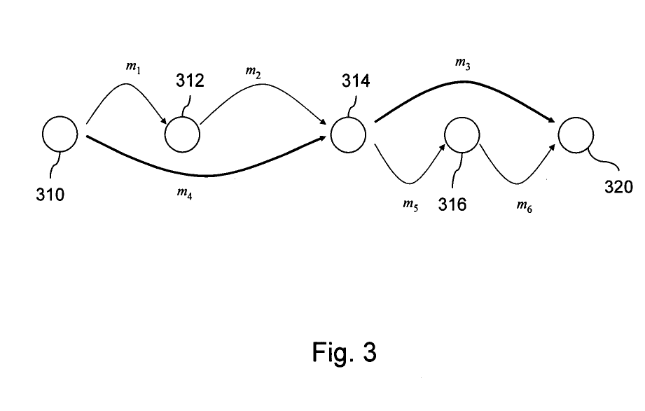

In one embodiment of the present invention, when the messaging model identifies multiple ways to encode logged requests as a sequence of messages, update propagation function 114 chooses the least-cost encoding. Illustrated by the example provided in FIG. 3, several alternative sequences of messages (e.g., m1 to m6) may be propagated by update propagation function 114 to remote information object 120 in order to communicate a sequence of update requests from log 112. In one embodiment, this sequence of update requests would update remote information object 120 from an initial state 310 to a synchronized state 320.

In one embodiment, remote information object 120 is updated from initial state 310 to synchronized state 320 by update propagation function 114 sending a sequence of messages comprising messages m1, m2 and m3. In one embodiment, message m1 updates remote information object 120 from initial state 310 to updated state 312; message m2 updates remote information object 120 from updated state 312 to updated state 314; and message m3 updates remote information object 120 from updated state 314 to synchronized state 320.

In one embodiment, remote information object 120 is updated from initial state 310 to synchronized state 320 by update propagation function 114 sending a sequence of messages comprising messages m4, m5 and m6. In one embodiment, message m4 updates remote information object 120 from initial state 310 to updated state 314; message m5 updates remote information object 120 from updated state 314 to updated state 316; and message m6 updates remote information object 120 from updated state 316 to synchronized state 320.

In one embodiment update propagation function 114 evaluates the possible combinations of messages m1 to m6 and chooses the messages that require the least-cost to encode. In one embodiment, update propagation function 114 determines the least-cost encoding through a shortest path algorithm. For example, as opposed to encoding and sending messages m1 and m2 to reach state 314 from initial state 310, state 314 can be reached by encoding and sending the single message m4. Similarly, as opposed to encoding and sending messages m5 and m6 to update remote information object 120 from state 314 to synchronized state 320, synchronized state 320 can instead be reached by encoding and sending the single message m3. Applying a shortest path algorithm, update propagation function 114 would only propagate messages m3 and m4 because those messages provide the shortest path for updating remote information object 120 from initial state 310 to synchronized state 320.

As would be appreciated by one skilled in the art upon reading this specification, a shortest path algorithm is only one criteria which could be applied to determine the messages that require the least-cost to encode. For example, in one embodiment, based on the application-layer message formats defined by messaging model, message m4 might require a longer sequence of bits for transmission, or might require greater computing resources to encode, than message m1 and m2 combined. Thus using a least cost criteria based on either total bit length or encoding effort, update propagation function 114 would choose to send m1 and m2 under these circumstances, rather than m4.

Several means are available to implement one or more of the update propagation function, the update reception function, the request logging function and the log discussed with respect to the current invention. These means include, but are not limited to, digital computer systems, programmable controllers, or field programmable gate arrays. Therefore other embodiments of the present invention are program instructions resident on computer readable media which when implemented by such processors, enable the processors to implement embodiments of the present invention. As previously discussed, a messaging model of one embodiment of the present defines 1) valid application-layer message formats for protocol compliant messages, 2) the state space structure and update operations which apply to the local information object 108, 3) and message semantics which correlate the update operations with protocol compliant messages. In one embodiment, program instructions for one or more of the update propagation function, the update reception function, the request logging function and the log are generated by one or more automated software generation tools based on the messaging model.

Computer readable media include any form of computer memory, including but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An information object replication system, the system comprising:
a log adapted to store records;
a request logging function adapted to record a sequence of updates sent by one or more local applications to a local information object in the log; and
an update propagation function in communication with the log, the update propagation function adapted to communicate one or more messages to one or more remote information objects, wherein the one or more messages represent updates to the local information object based on the sequence of updates, the update propagation function is further adapted to generate the one or more messages based on application-layer message formats and message semantics defined by a message model.

2. The system of claim 1, wherein the update propagation function is adapted to evaluate the contents of the log and correlate the sequence of updates recorded in the log with the one or more messages based on the message semantics.

3. The system of claim 2, wherein the update propagation function is further adapted to correlate the sequence of updates with the one or more messages based on the satisfaction of one or more preconditions defined by the message semantics.

4. The system of claim 3, wherein the update propagation function is further adapted to determine if the one or more preconditions is satisfied by referencing one or both of the local information object, and the sequence of updates.

5. The system of claim 1, wherein the update propagation function determines which source object states to propagate to the one or more destination objects based on information quality of service accuracy requirements.

6. The system of claim 1, wherein the update propagation function applies a compression algorithm that transforms the sequence of requests from the request logging function into a compressed sequence of requests.

7. The system of claim 1, further comprising:
an update reception function, wherein the update reception function is adapted to output a second sequence of updates to the local information object based on a message received from a remote computer system.

8. The system of claim 7, wherein the update reception function correlates the message received from a remote computer system with the second sequence of updates based on the application-layer message formats and message semantics defined by the message model.

9. The system of claim 8, wherein the update reception function is further adapted to correlate the message received from a remote computer system with the second sequence of updates based on the satisfaction of one or more preconditions defined by the message semantics.

10. A method for propagating information object updates, the method comprising:
logging a sequence of update requests made to a local information object by one or more applications;
correlating the sequence of update requests with one or more message formats based on message semantics defined by a message model;
encoding the sequence of update requests as one or more messages based on application-layer message formats defined by the message model; and
communicating the one or more messages to one or more remote computer systems.

11. The method of claim 10, further comprising:
correlating the sequence of updates with the message format based on satisfying one or more preconditions defined by the message semantics.

12. The method of claim 11, further comprising:
determining if the one or more preconditions are satisfied by referencing one or both of the local information object, and the sequence of updates.

13. The method of claim 10, further comprising:
applying a compression algorithm that transforms the sequence of update requests into a compressed sequence of update requests.

14. The method of claim 10, wherein communicating the one or more messages further comprises timing the propagation of the one or more messages to the one or more remote computer systems based on one or both of information quality of service accuracy requirements and information quality of service freshness requirements.

15. The method of claim 10, wherein when the messaging model identifies multiple ways to encode the sequence of update requests as one or more messages, encoding the sequence of update requests further comprises:
choosing the one or more messages that result in a least cost encoding.

16. The method of claim 10, further comprising:
receiving a message at a first remote computer system of the one or more remote computer systems;
correlating the message received with a second sequence of updates based on the application-layer message formats and message semantics defined by the message model; and
outputting the second sequence of updates to a remote information object.

17. The method of claim 10, further comprising:
correlating the message received with a second sequence of updates based on satisfying one or more preconditions defined by the message semantics.

18. The method of claim 10, further comprising:
receiving a message from a first remote computer system of the one or more remote computer systems;
correlating the message received from the first remote computer system with a second sequence of updates based on the application-layer message formats and message semantics defined by the message model; and
outputting the second sequence of updates to the local information object.

19. The method of claim 18, further comprising:
generating computer-executable instructions for performing one or more of the logging a sequence of update requests, the correlating the sequence of update requests, the encoding the sequence of update requests, the communicating the one or more messages, the receiving a message, the correlating the message received and the outputting the second sequence of updates, based on the messaging model.

20. The method of claim 18 further comprising:
correlating the message received from the first remote computer system with a second sequence of updates based on satisfying one or more preconditions defined by the message semantics.

21. A computer-readable medium having computer-executable instructions for performing a method for propagating information object updates, the method comprising:
logging a sequence of update requests made to a local information object by one or more applications;
correlating the sequence of update requests with one or more message formats based on message semantics defined by a message model;
encoding the sequence of update requests as one or more messages based on application-layer message formats defined by the message model; and
communicating the one or more messages to one or more remote computer systems.

22. The computer-readable medium of claim 21, further comprising:
correlating the sequence of updates with the message format based on satisfying one or more preconditions defined by the message semantics.

23. The computer-readable medium of claim 22, further comprising:
determining if the one or more preconditions are satisfied by referencing one or both of the local information object, and the sequence of updates.

24. The computer-readable medium of claim 21, further comprising:
applying a compression algorithm that transforms the sequence of update requests into a compressed sequence of update requests.

25. The computer-readable medium of claim 21, wherein communicating the one or more messages further comprises timing the propagation of the one or more messages to the one or more remote computer systems based on one or both of information quality of service accuracy requirements and information quality of service freshness requirements.

26. The computer-readable medium of claim 21, wherein when the messaging model identifies multiple way to encode the sequence of update requests as one or more messages, encoding the sequence of update requests further comprises:
choosing the one or more messages that result in a least cost encoding.

27. The computer-readable medium of claim 21, further comprising:
receiving a message from a first remote computer system of the one or more remote computer systems;
correlating the message received from the first remote computer system with a second sequence of updates based on the application-layer message formats and message semantics defined by the message model; and
outputting the second sequence of updates to the local information object.

28. The computer-readable medium of claim 27, wherein the computer-executable instructions are generated by one or more automated software generation tools based on the messaging model.

29. An information object replication system, the system comprising:
means for logging a sequence of update requests made to a local information object by one or more applications;
means for correlating the sequence of update requests with one or more message formats based on message semantics defined by a message model, the means for correlating responsive to the means for logging;
means for encoding the sequence of update requests as one or more messages based on application-layer message formats defined by the message model, the means for encoding responsive to the means for correlation; and
means for communicating the one or more messages to one or more remote computer systems, the means for communicating responsive to the means for encoding.

30. The system of claim 29, further comprising:
means for receiving a message from a first remote computer system of the one or more remote computer system;
means for correlating the message received from the first remote computer system with a second sequence of updates based on the application-layer message formats and message semantics defined by the message model, the means for correlating responsive to the means for receiving; and
means for updating the local information object based on the second sequence of updates, the means for updating responsive to the means for correlating.
